(19) United States
(12) Patent Application Publication
(10) Pub. No.: US 2021/0069732 A1
(43) Pub. Date: Mar. 11, 2021

(54) SUPERCRITICAL HYDROCYCLOTRON AND RELATED METHODS

(71) Applicants: Thomas Erik Loop, Seattle, WA (US); James D. Flynn, Auburn, WA (US); G. Graham Allan, Kenmore, WA (US)

(72) Inventors: Thomas Erik Loop, Seattle, WA (US); James D. Flynn, Auburn, WA (US); G. Graham Allan, Kenmore, WA (US)

(73) Assignee: Xtrudx Technologies, Inc., Seattle, WA (US)

(21) Appl. No.: 16/564,962

(22) Filed: Sep. 9, 2019

(51) Int. Cl. B04C 5/04; B04C 5/081; B04C 5/107; B01J 3/00; B29B 17/02

(52) U.S. Cl. CPC B04C 5/04; B04C 5/081; B04C 5/107; B29B 2017/0293; B29B 17/02; B29B 2017/0231; B01J 3/008

(57) ABSTRACT

A supercritical hydrocyclotron for transforming one or more selected polymeric materials into a plurality of reaction products via supercritical or near-supercritical water reaction that enable the rapid and economic conversion of solid biomass and/or waste plastic materials (i.e., organic materials) into smaller liquid and gaseous hydrocarbon molecules—smaller hydrocarbon molecules that, in turn, are useful as chemical feedstock materials including, for example, liquid transportation fuels and bio-adhesives. The innovative supercritical hydrocyclonic systems and related mobile units disclosed herein comprise, in combination, (1) a supercritical water (or near-supercritical water) treatment system for converting organic materials into smaller hydrocarbon molecules, and (2) a hydrocyclonic separation system for recovering the smaller hydrocarbon molecules from the combined water/hydrocarbon effluent.

### CROSS-REFERENCE TO RELATED APPLICATIONS

This application is a continuation-in-part of U.S. application Ser. No. 15/943,691 filed on Apr. 4, 2018 (now U.S. Pat. No. 10,421,052), which application is a continuation-in-part of U.S. application Ser. No. 14/549,508 filed on Nov. 20, 2014 (now U.S. Pat. No. 9,932,285), which application is a continuation-in-part of U.S. application Ser. No. 13/297,217 filed on Nov. 15, 2011 (now U.S. Pat. No. 8,980,143), which application claims the benefit of priority to U.S. application Ser. No. 12/828,102 filed on Jun. 30, 2010 (now U.S. Pat. No. 8,057,666) and U.S. application Ser. No. 12/402,489 filed on Mar. 11, 2009 (now U.S. Pat. No. 7,955,508), which applications claim the benefit of priority to U.S. Provisional Application No. 61/110,505 filed on Oct. 31, 2008, and to U.S. Provisional Application No. 61/035,380 filed on Mar. 11, 2008, all of which applications are all incorporated herein by reference in their entireties for all purposes.

### TECHNICAL FIELD

The present invention relates generally to biomass and waste plastics conversion systems and, more specifically, to biomass and/or waste plastics conversion systems, machines, apparatuses, and related methods that utilize supercritical water (and/or near-supercritical water) to treat and transform naturally occurring polymers and/or man-made synthetic polymers (collectively, organic materials) into smaller hydrocarbon molecules useful as chemical feedstock materials, including liquid transportation fuels and bio-adhesives.

### BACKGROUND OF THE INVENTION

Everyday the Sun pours down onto the Earth a vast quantity of radiant energy that is many, many times greater than the total now used by Mankind. Some of this energy, together with carbon dioxide and water, Nature traps in trees and other plants by conversion (called photosynthesis) into giant chemical molecules, collectively called biomass. The major components (about 60% to 80%) of this mixture are polysaccharides. These are long and substantially linear chains, the individual links of which are simple sugars. The remaining component (about 15% to 25%) is called lignin and is a complex network of joined aromatic rings of the type found in liquid transportation fuels. The energy trapped within plants can be recovered, in part, by breaking down the long chains into their constituent sugar links for subsequent standard fermentation into bioethanol. In contrast, the breakdown of the lignin network can yield simple aromatic compounds—simple aromatic compounds that are especially useful for either (1) direct incorporation/blending into liquid transportation fuels, and/or (2) further synthesis into bio-based phenolic adhesives.

As with all living things, all biomass eventually dies and—through a process called sedimentary diagenesis, which process occurs naturally, over geological time, deep within the Earth—is transformed into a hard, carbonaceous, rock-like fossil material called kerogen. Kerogen, commonly defined as the insoluble macromolecular organic matter dispersed in sedimentary rocks, is by far the most abundant form of organic matter found on Earth. Kerogen, in turn, naturally breaks down over geologic time (via supercritical water reactions occurring deep within the Earth) into lower-molecular-weight hydrocarbon products including bitumen, oil, and natural gas. Kerogen is, therefore, the precursor material of most all fossil fuel and petroleum products currently used by Mankind.

Water, a continuous hydrogen-linked three-dimensional network of self-aligning triatomic H₂O molecules, possesses unique, anomalous, and well-studied properties. Water is ubiquitous in Nature, both on Earth and in the Heavens, and commonly exists in solid, liquid, and gaseous form. Water also commonly exists in another much less familiar form (phase of matter) near and beyond its so-called ‘critical point’. This highly energetic and more exotic state of water subsists in the critical and supercritical regions of water's state-space where the physical distinction between gas and liquid largely disappears, and where only a single hot homogeneous equilibrium phase remains. Water, under supercritical conditions—that is, water near and beyond its critical temperature (T_{c}) and critical pressure (P_{c}), possesses its own peculiar set of properties that differ substantially from those of ordinary liquid water (water at ambient conditions).

In ordinary water, the critical point is observed to occur at about 647K (374° C. or 705° F.) and 22.06 MPa (3200 psia or 218 atm). In the vicinity about the critical point, the physical properties of water's liquid and vapor phases change abruptly, with both phases becoming substantially the same with properties substantially opposite from those of ordinary liquid water. For example, under ordinary ambient conditions, water is a nearly incompressible liquid that has a low thermal expansion coefficient, a high dielectric constant, and is an excellent solvent for electrolytes. Near and above its critical point, however, all of these properties change into their opposites; water becomes compressible, expandable, a poor dielectric, a bad solvent for electrolytes, and prefers to mix (solvate) with nonpolar gases and is an excellent solvent of organic molecules. Unlike ordinary water, supercritical water can be continuously compressed from gas-like to liquid-like densities while being maintained as a single-phase fluid.

Beginning with the dawn of the Industrial Revolution and through various means, Mankind has mastered the art of extracting natural resources from the Earth, including coal, oil, and natural gas, for his and her further exploitation and benefit. Some of these extracted ‘fossil materials’ are converted (at the chemical factory) into, among other things, an array of different kinds of synthetic polymers called plastics. Among the most commercially significant plastics made by Mankind, polystyrene (PS), polyethylene (PE) and polypropylene (PP), all are made of long polymer chains that contain only carbon and hydrogen atoms in amounts similar to the hydrocarbons found in diesel and gasoline engine fuels. Thus, the molecules in diesel and gasoline are chemically similar to the polymers that constitute many plastics, but are much smaller in size. It has, therefore, been recognized by scientists and chemical engineers that if the long chains of these types of plastics could be broken down into smaller pieces, these moieties could find use as liquid transportation fuels (among other possible uses).

As a consequence of the Industrial Revolution, Mankind now lives in the Age of Plastics. In today's modern era, the continuous influx of waste plastics polluted into Mankind's environment has created a worldwide environmental crisis. To wit, in 2018 alone (and according to the World Economic Forum), an estimated 360 million tons of plastic products were manufactured worldwide. With a rapidly growing world population driving demand, the production of plastics is expected to reach 500 million tons by 2025 and a staggering 619 million by 2030. Of all the plastic waste produced globally, only 9% has ever been recycled—the remainder has been and continues to be discarded (and thus presents an available resource and a huge missed opportunity).

In view of this readily available chemical resource (and according to the American Chemistry Council), investments in chemical recycling of waste plastics in 260 new facilities across the United States would lead to a stronger, more circular economy that would result in (1) 38,500 new jobs supported by new advanced plastic recycling and recovery facilities, (2) $2.2 billion dollars in annual payrolls, and (3) $9.9 billion in U.S. economic output attributable directly to new plastics recycling and recovery operations. Thus, there appears to be substantial justification for investments into advanced plastic recycling and recovery technologies.

Nowadays, and from both legal and scientific perspectives, it has become a generally accepted fact that Mankind's continuous combustion of fossil fuels (and subsequent release of carbon dioxide (CO₂) into the Earth's atmosphere) has contributed to global warming. In addition, it is also generally accepted that plastic pollution is a serious environmental concern. Accordingly, it is self-evident that in order to reduce both CO₂ emissions (to, hopefully, retard and/or reverse global warming) and plastics pollution, Mankind needs to (1) reduce its reliance on, and use of fossil fuels and fossil material resources, and (2) better use its abundant biomass and waste plastics resources (as preferred alternatives to the use of native fossil materials). In order to achieve these objectives, new technologies are needed that enable the rapid and economic conversion of abundant biomass and waste plastics into smaller more useful chemical fragments—and are able to do so on a large-scale, commercially practical, and energy efficient way. The present invention fulfils these needs and provides for further related advantages.

### SUMMARY OF THE INVENTION

The present invention is directed to systems, including mobile units sized and configured to fit within standard intermodal cargo containers (so as to be readily transportable by land, rail, and/or sea), that enable the rapid and economic conversion of solid biomass and/or waste plastic materials (i.e., organic materials) into smaller liquid and gaseous hydrocarbon molecules—smaller hydrocarbon molecules that, in turn, are useful as chemical feedstock materials including, for example, liquid transportation fuels and bio-adhesives. The innovative systems and mobile units disclosed herein (aka “supercritical hydrocyclotrons”) comprise, in combination, (1) a supercritical water (or near-supercritical water) treatment system for converting organic materials into smaller hydrocarbon molecules, and (2) a hydrocyclonic separation system for recovering the smaller hydrocarbon molecules from the combined water/hydrocarbon effluent. As disclosed herein, the supercritical water treatment system is capable of harnessing the remarkable powers of supercritical water (SCW) in a highly controlled manner to achieve rapid biomass/waste plastics hydrothermal liquefaction with near zero char formation, whereas the accompanying hydrocyclonic separation system is capable of continuously separating the resulting liquified and/or gaseous biomass/waste plastics fragments (i.e., smaller hydrocarbon molecules) from the combined hot flowing water/hydrocarbon mixture effluent. Plainly put, organic materials are fed into the supercritical hydrocyclonic system, broken down via supercritical water reaction into smaller more valuable hydrocarbon molecules, which, in turn, are recovered via hydrocyclonic separation for subsequent re-sale (e.g., to the chemical factory, petroleum refinery, and/or advanced integrated biorefinery—as the case may be).

In a preferred embodiment and in a first aspect, the present invention is directed to a ‘supercritical hydrocyclotron’ for transforming one or more selected organic materials into a plurality of reaction products via supercritical or near-supercritical water reaction. As disclosed herein, the innovative supercritical hydrocyclotron of the present invention comprises, in fluidic series: (1) an extruder having an inlet and a downstream outlet, wherein the downstream outlet is coincident with the longitudinal axis of the extruder; (2) a steam generator fluidically connected to a downstream inlet manifold, wherein the inlet manifold forms a circular ring having a plurality of inwardly facing exit portals, wherein the plurality of exit portals is circumferentially positioned about the inner surface of the ring; (3) a tubular reactor having an interior space fluidically connected to an inlet end and an outlet end, wherein the inlet end of the tubular reactor is adjacent and fluidically connected to both (i) the outlet of the extruder, and (ii) the plurality of circumferentially positioned exit portals of the inlet manifold.

As further disclosed herein, the inlet end of the reactor further comprises an axially aligned occlusion (preferably cone-shaped) having one or more through-holes or passageways (to allow passage of the molten extrudate/water mixture). The tubular reactor is configured such that, under operating conditions, a flowing molten polymeric (organic material) extrudate exiting the outlet of the extruder and entering into the interior space of the tubular reactor is spread out and thinned by the cone-shaped occlusion while simultaneously being radially impinged upon (struck) by continuously flowing hot compressed water and/or supercritical water that is exiting the plurality of circumferentially positioned exit portals (to thereby yield the plurality of hydrocarbon reaction products mixed with water). For purposes of enhanced conceptualization, this configuration may be thought of as an extremely hot circular shower that is forcefully and inwardly showering a central and cylindrically flowing molten extrudate with SCW, while the flowing molten extrudate is being spread out and thinned by the hard surface of a tip section of an axially cone-shaped obstruction (thereby ensuring rapid and complete mixing of the target organic material with hot compressed water and/or supercritical water).

As still further disclosed herein and in a second aspect, the outlet end of the tubular reactor is fluidically connected to: (4) an expansion chamber (for cooling and initial coalescing of the hydrocarbon reaction products), which, in turn is fluidicly connected to (5) a hydrocyclonic separator, wherein the hydrocyclonic separator is configured to spin and substantially separate the plurality of hydrocarbon reactions products from the water and comprises, in fluidic series, (i) a cyclindrical swirl chamber section, (ii) a concentric tapered reducing section, and in some preferred embodiments (iii) a cylindrical tail section. Under operating conditions, the plurality of hydrocarbon reaction products mixed with water exiting the expansion chamber enters into the cyclindrical swirl chamber section (of the hydrocyclonic separator) through a tangential inlet and creates a flowing vortex with a reverse-flowing central core (all within the hydrocyclonic separator). The plurality of hydrocarbon reaction products exits the hydrocyclonic separator through an axially aligned reaction products ejection port located on the cyclindrical swirl chamber section, whereas the water exits the hydrocyclonic separator through an axially aligned tail section outlet (and is preferably re-used as feed water to the steam generator).

In further embodiments and in a third aspect, the system further comprises a movable (adjustably extendable) ram centrally positioned within the tubular reactor. The ram (which may take the form of a rod or piston) is movable back and forth within and along the longitudinal axis of the tubular reactor to thereby quickly increase or decrease the volume of the interior space of the tubular reactor. In this way, the residence or reaction time of the supercritical water reaction occurring within the tubular reactor (during operation of the system) may be selectively and readily changed (with longer residence times corresponding to larger reactor volumes). This ‘on-the-fly’ changeability of the reactor volume advantageously allows ‘tuning’ of the molecular-weight-distribution of the resulting hydrocarbon reaction products (with gaseous and lower molecular-weight-distributions corresponding to longer residence times).

In another preferred embodiment, the present invention is directed to a method for converting solid biomass and/or waste plastic materials (organic materials) into smaller liquid and gaseous hydrocarbon molecules by means of the inventive supercritical hydrocyclotrons disclosed herein, the inventive method comprising the steps of: (1) conveying the solid biomass and/or waste plastic materials through a conveyor (e.g., an extruder or other suitable pump) and into a downstream tubular reactor that comprises an axially aligned occlusion (preferably cone shaped) having one or more through-holes or passageways, wherein the occlusion is configured to spread and thin the solid biomass and/or waste plastic materials; (2) generating supercritical water or near-supercritical water substantially free of salts and minerals; (3) conveying the supercritical water or near-supercritical water into a downstream inlet manifold, wherein the inlet manifold forms a ring having a plurality of inwardly facing exit portals, wherein the plurality of exit portals is circumferentially positioned about the inner surface of the ring; (4) ejecting the supercritical water or near-supercritical water through the plurality of exit portals circumferentially positioned about the inner surface of the ring and into the tubular reactor and about the occlusion such that the supercritical water or near-supercritical water strikes and reacts with the solid biomass and/or waste plastic materials to yield the plurality of hydrocarbon reaction products mixed with water; and (5) substantially separating the plurality of hydrocarbon reactions products from the water by creating a flowing vortex with a reverse-flowing central core within a hydrocyclonic separator, and then removing the plurality of hydrocarbon reaction products from the hydrocyclonic separator through an axially aligned reaction products ejection port while simultaneously removing the water through an axially aligned tail section outlet.

In accordance with the biomass and/or waste plastic material liquefaction (and/or gasification) methods disclosed herein, a specialized single screw extruder is preferably utilized to convey, while heating and increasing pressure from atmospheric to about or greater than 22.06 MPa (3200 psia or 218 atm), a selected solid biomass and/or waste plastic feedstock organic material from an upstream hopper to a downstream tubular reactor. The selected feedstock organic material becomes heated, pressurized, and plasticized/moltenized (i.e., turns into a semi-solid molten state) while travelling down the heated barrel of the extruder before exiting through a specialized extruder outlet (or die). The extruder outlet, in turn, is fluidically connected (via a specialized metering valve) to an adjacent inlet manifold that, in turn, includes a plurality of circumferentially positioned and inwardly directed exit ports. The exit ports are configured to circumferentially inject supercritical or high-energy water into the tubular reactor such that the water impinges upon (strikes) the molten feedstock organic material (that is flowing centrally therethrough during operation of the system). A novel cone-shaped occlusion (having a plurality of reactant flow through-holes or passageways positioned about a base plate of the cone portion) is centrally positioned and axially aligned at the reactor's front end to facilitate spreading and thinning of the centrally flowing molten feedstock material (as the material flows over the tip of the cone), thereby enabling the near-instantaneous penetration and mixing of the centrally flowing molten feedstock material with regulated (or minimum) amounts of supercritical/high-energy water.

The reaction times within the variable volume flow-through SCW reactor may be, in some embodiments, controlled by adjustably and/or selectively positioning the ram (centrally positioned within the tubular reactor) to either contract (“ram-in”) or expand (“ram-out”) the volume of the otherwise tubular reaction chamber. In other embodiments, the length of the ram is preselected and nonadjustable.

In still further embodiments, a circumferentially positioned, high efficiency alternating current induction coil (that is part of an induction heater) surrounds the tubular reactor and supplies additional heat energy when needed (for example, to maintain steady state conditions during operation of the system). Similarly, a plurality of outer heating bands is positioned about the barrel of the extruder for preheating the selected feedstock material (as the organic material travels down the barrel of the extruder). In this way, a minimum amount of water is conveyed, heated, pressurized and used for reaction and liquefaction (and/or gasification). Moreover, the reaction (residence) time may be appropriately adjusted (tuned) to accommodate different types of polymeric material feedstocks.

These and other aspects of the present invention will become more evident upon reference to the following detailed description and accompanying drawings. It is to be understood, however, that various changes, alterations, and substitutions may be made to the specific embodiments disclosed herein without departing from their essential characteristic or scope.

### BRIEF DESCRIPTION OF THE DRAWINGS

The drawings are intended to be illustrative and symbolic representations of certain exemplary embodiments of the present invention and as such they are not necessarily drawn to scale. In addition, it is to be expressly understood that the relative dimensions and distances depicted in the drawings (and described in the “Detailed Description of the Invention” section) are exemplary and may be varied in numerous ways. Finally, like reference numerals have been used to designate like features throughout the several views of the drawings.

In view of the foregoing, FIG. 1 illustrates a process flow diagram that shows the flow of materials into and out of the various major components of a supercritical hydrocyclonic system for transforming solid biomass and/or waste plastic feedstock organic materials into hydrocarbon products, including simple sugar solutions and/or oily hydrocarbon mixtures, via supercritical water reaction in accordance with an embodiment of the present invention.

FIGS. 2A-D show a solid perspective, a see-through perspective, an end, and a cross-sectional view of the extruder component of the supercritical hydrocyclotron system depicted in FIG. 1.

FIGS. 3A-D show a solid perspective, a see-through perspective, a top, and a side cross-sectional view of the steam generator component of the supercritical hydrocyclotron system depicted in FIG. 1.

FIGS. 4A-J show various different views (e.g., solid perspective, see-through, exploded, and cross-sectional) of the supercritical water reactor component of the supercritical hydrocyclotron system depicted in FIG. 1, including various views of its various main sub-components including a manifold baseplate, a manifold housing, an inner manifold distributor, a coned shape occlusion, and tubular reactor shells (in accordance with an embodiment of the present invention).

FIGS. 5A-F show various different views (e.g., solid perspective, see-through, exploded, and cross-sectional) of the supercritical water reactor component of the supercritical hydrocyclotron system depicted in FIG. 1, including various views of its various main sub-components including a manifold baseplate, a manifold housing, an inner manifold distributor, a coned shape occlusion, and tubular reactor shells (in accordance with another embodiment of the present invention).

FIG. 6 shows a see-through perspective side view of a hydrocyclonic separator having a flowing vortex with a reverse-flowing central core, wherein the hydrocarbon reaction products exits the hydrocyclonic separator through an axially aligned reaction products ejection port connected at the end of a centrally positioned vortex finder, which, in turn, is located within the cyclindrical swirl chamber section, whereas the water exits the hydrocyclonic separator through an axially aligned tail section outlet in accordance with an embodiment of the present invention.

### DETAILED DESCRIPTION OF INVENTION

The present invention is directed to supercritical hydrocyclotronic systems capable of converting solid biomass and/or waste plastic materials (i.e., organic materials) into smaller liquid and gaseous hydrocarbon molecules—smaller hydrocarbon molecules that, in turn, are generally useful as chemical feedstock materials including, for example, liquid transportation fuels and bio-adhesives. Unlike known SCW conversion schemes that mix liquid water together with a target reagent (organic material) before heating (thereby using excessive amounts of water, as well as energy to heat and pressurize the same), the novel supercritical hydrocyclotronic systems of the present invention heat the liquid water and target reagent (organic material) separately and then forcefully mixes them together in a specialized tubular reactor (wherein the heated supercritical or near-supercritical water is controllably injected about and into the target organic material that has already been pre-heated and is continuously flowing therethrough). In this way, the use of a highly regulated (or minimum) amount of water for reaction with, and liquefaction and/or gasification of, a wide selection of organic materials is made possible. In addition, the volume (and residence time) of the novel SCW reactor disclosed herein is selectively adjustable (tunable) to enable the selective altering and/or tuning of the distribution of the resulting hydrocarbon molecules produced by supercritical water reaction (with longer residence times generally resulting in smaller molecular fragments).

Advantageously, the novel supercritical hydrocyclotronic systems of the present invention are able to convert, in a very energy efficient way, a wide range of organic materials into valuable chemical fragments (without any significant char formation) within seconds (generally less than 10 seconds). The supercritical hydrocyclotronic systems disclosed herein (including mobile units thereof) thus enable the economic utilization of abundant biomass and waste plastics as viable renewable feedstocks (as opposed to native fossil fuel derived feedstocks) for conversion into alternative liquid transportation fuels and valuable green-chemical products.

Referring now to FIG. 1, an overview “process flow diagram” of the inventive “supercritical hydrocyclotronic” system 10 is presented that illustrates the various major components (of the inventive system 10) in relation to one another and to the flow of materials (i.e., selected organic material feedstock, water, and hydrocarbon molecules reaction products) into and out of the various major components. As shown, the inventive system 10 includes four different processing zones; namely, (1) an upstream extruder-based biomass and/or waste plastic materials conveyance and plasticization/moltenization zone 100 where a selected solid polymeric organic feedstock material is fed, conveyed, heated, pressurized, and transformed into a molten state; (2) an upstream steam generation and manifold distribution zone 200 where ordinary liquid water is pumped, heated and pressurized to supercritical, or near supercritical, conditions; (3) a central supercritical water reaction zone 300 where the plasticized/moltenized polymeric extrudate material and high-energy/SCW water confluence and undergo chemical reaction; and (4) a downstream pressure let-down and reaction product separation zone 400 where the hydrocarbon reaction products including, for example, sugar solutions, hydrocarbon mixtures, and water (and sometime gases), are depressurized, cooled, and separated from one another.

As shown in FIG. 1, these four different zones 100, 200, 300, 400 are mechanically and fluidicly connected to one another to form a single unitary supercritical hydrocyclotronic system 10 that, in some embodiments, is mobile and, thus, readily transportable by land or by sea. The inventive system 10 disclosed herein is fully scalable (meaning capable, in some preferred embodiments, of processing up to 50 tons/day of feedstock material or more—depending on the size of the extruder component) and readily controllable (tuneable) to minimize the amount of water (and energy) needed to liquefy a wide range of biomass and/or waste plastic feedstock materials including, for example, raw biomass, lignin and all types of mixed waste plastic materials.

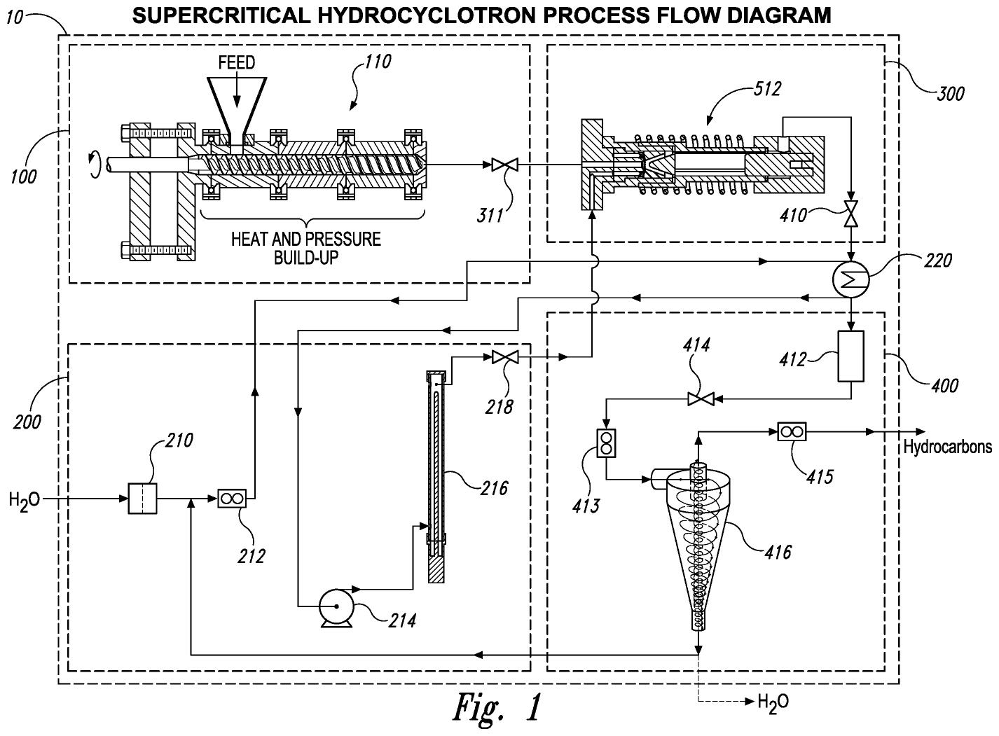

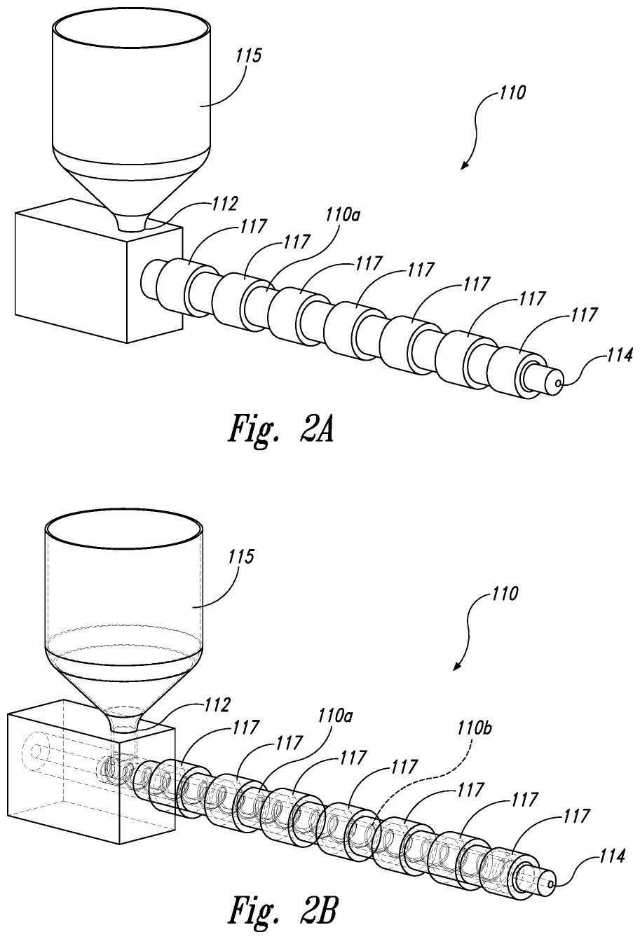

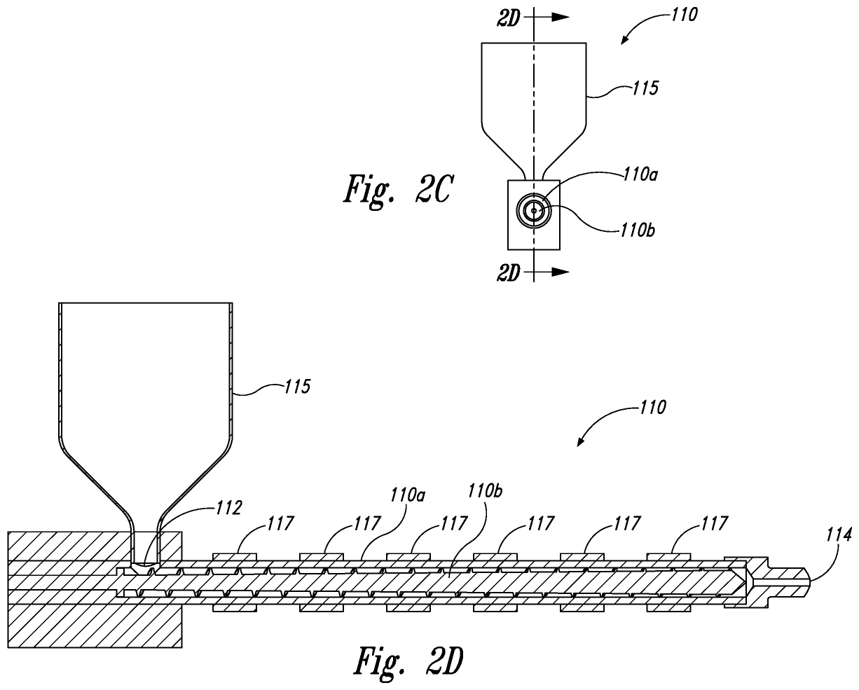

More specifically, and as depicted in the process flow diagram of FIG. 1 in view of FIGS. 2A-D (extruder views), the upstream extruder-based biomass and/or waste plastic materials conveyance and plasticization/moltenization zone 100 (of the inventive system 10) comprises a single screw extruder 110 having an inlet 112 and a downstream outlet 114, wherein the downstream outlet 114 is coincident with the longitudinal axis of the extruder 110. As shown, the extruder 110 includes an outer barrel 110a having an inner rotatable screw 110b (tapered) connected to an external motor (not shown). The external motor, in turn, is connected to an external electrical power source (also not shown). The extruder 110 includes a hopper 115 connected to the inlet 112 of the extruder and is used for holding and releasing/feeding a selected organic material (“feedstock”), in preferably either a pelletized or shredded form, into the extruder 110. To facilitate moltenization of the selected feedstock material, a plurality of outer heating bands 117 is positioned about the barrel 110a of the extruder 110. The outer heating bands 117 are energized, when additional heat is needed, by an alternating current (AC) power source (not shown). The plurality of outer heating bands 117 may be selectively energized or set, for example, to progressively maintain internal temperatures along the barrel 110a of the extruder 110 ranging from, for example, 150° F. to 550° F. (65.6° C. to 287.8° C.) (depending on the type of feedstock material being processed).

During operation of the supercritical hydrocyclotronic system 10, the selected organic material is continuously fed into the extruder 110 by means of the hopper 115—the feed material is then heated, pressurized, and becomes molten as it is conveyed from the inlet 112 to the downstream outlet 114. The speed of rotation of the inner screw 110b (which is governed by the motor) controls the flow rate of the molten extrudate. In certain embodiments, the plasticized/molten extrudate exiting the downstream outlet 114 of the extruder 110 is in the form of a continuously flowing cylinder of molten polymeric material (which, conceptually, may be thought of as being similar to a continuous spaghetti noodle exiting a pasta maker). Note: the term “extrudate” as used herein shall be broadly construed to encompass all materials that are pushed through a small opening or die, and is not limited to materials exiting the end of an extruder.

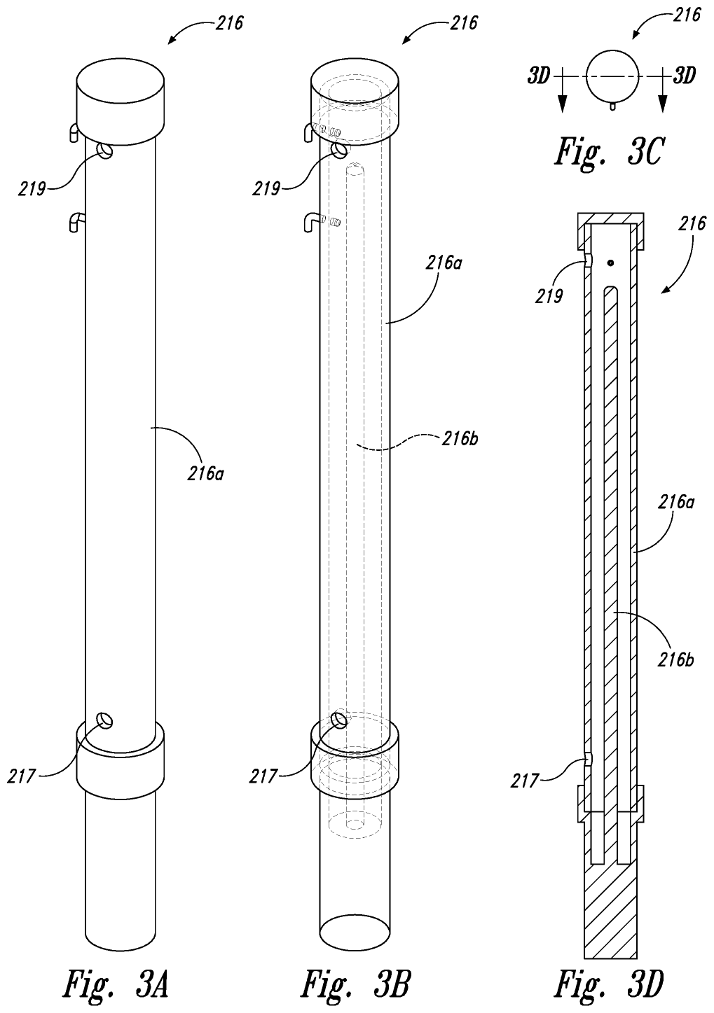

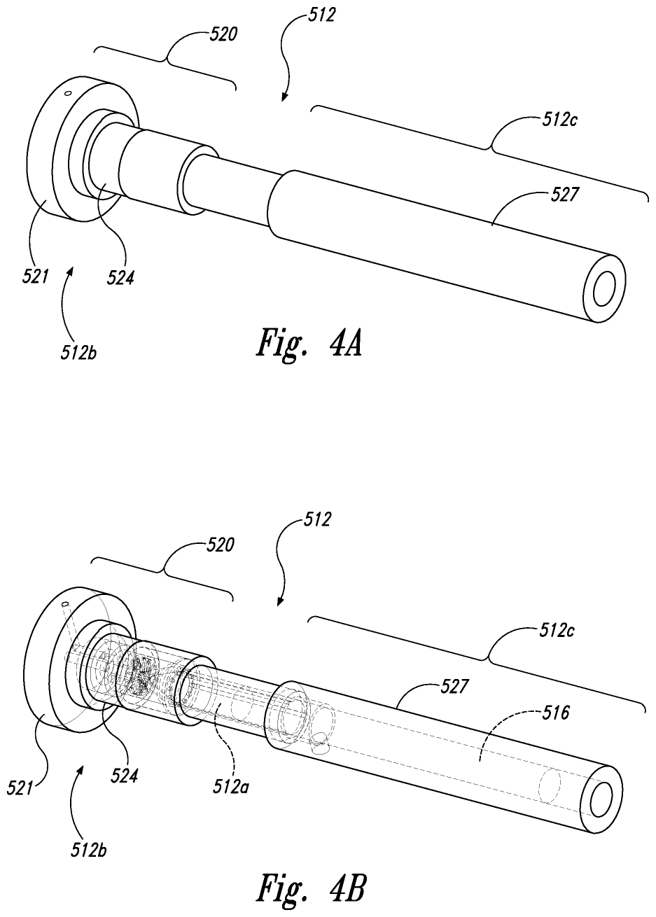

As further depicted in the process flow diagram of FIG. 1 in view of FIGS. 3A-D (steam generator views), the upstream steam generation and manifold distribution zone 200 (of the inventive system 10) comprises: an upstream water source (not shown); a water filtration system 210 (for removing trace impurities from the input feed water such that the water used in the system 10 is substantially free of minerals and salts and, preferably, is of laboratory grade quality); a flow meter 212 (for monitoring the flow rate of water entering into the system 10); a specialized high-pressure positive displacement pump assembly 214 (for continuously pumping liquid water at a steady/constant flow without pulsations); a steam generator 216 (for producing a continuous flow of supercritical water or high-energy water at near supercritical conditions and thus constitutes a type of boiler); a first high-pressure valve assembly 218 (for controlling the flow rate of the supercritical or high-energy water produced by the steam generator 216); and a pressure release valve for added safety (not shown).

Referring now to FIGS. 3A-D, the steam generator 216 component (of the inventive system 10) is shown to consist essentially of a vertically oriented outer pipe 216a concentrically positioned about an inner heater rod 216b. The inner heater rod 216b, in turn, is electrically connected to an alternating current (AC) power source (not shown) and, thus, may be selectively (computer controlled) energized to maintain internal temperatures of up to about 1,000° F. (537.8° C.) and pressures up to about 5,000 psia (34.5 MPa or 340.2 atm) and even up to 10,000 psia (69.0 MPa or 680.4 atm). During operation of the system 10, high-pressure water exiting the high-pressure pump assembly 214 is fed into the bottom of the steam generator 216 by way of a water inlet 217. The water is then heated, further pressurized and becomes highly energized as it moves upward through the annular space that exists between the inner heater rod 216b and the concentrically positioned outer pipe 216a. The high-energy water is then expelled out of the steam generator 216 by way of the high-energy water outlet 219 positioned at the top of the steam generator 216.

In certain preferred embodiments, the various components that comprise the system 10 are each made of type 316 stainless steel and/or a nickel/chromium alloy because of the superior resistance to corrosion these metals possess.

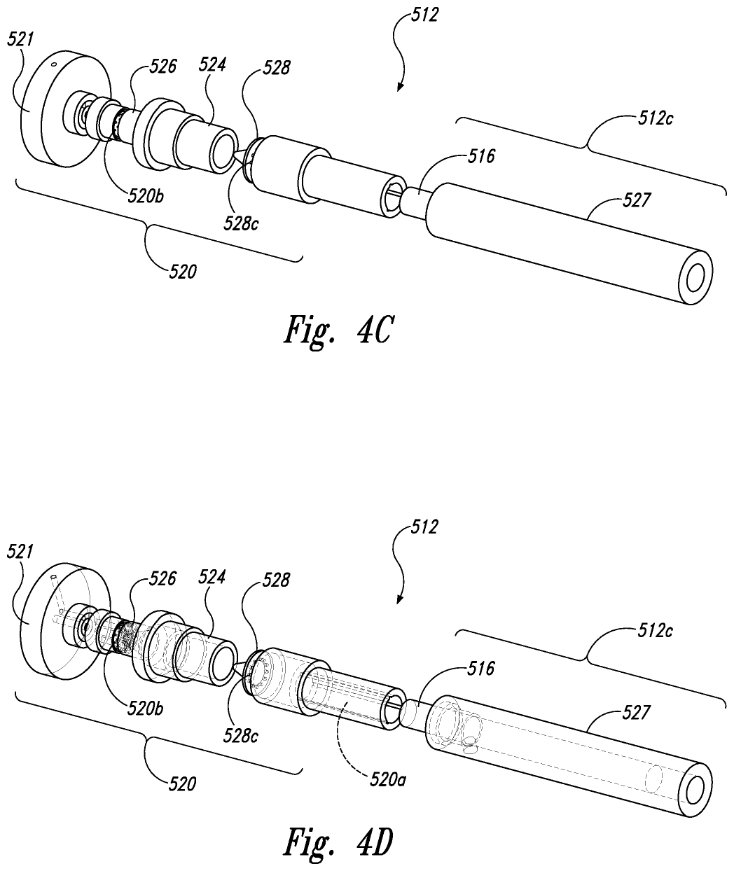

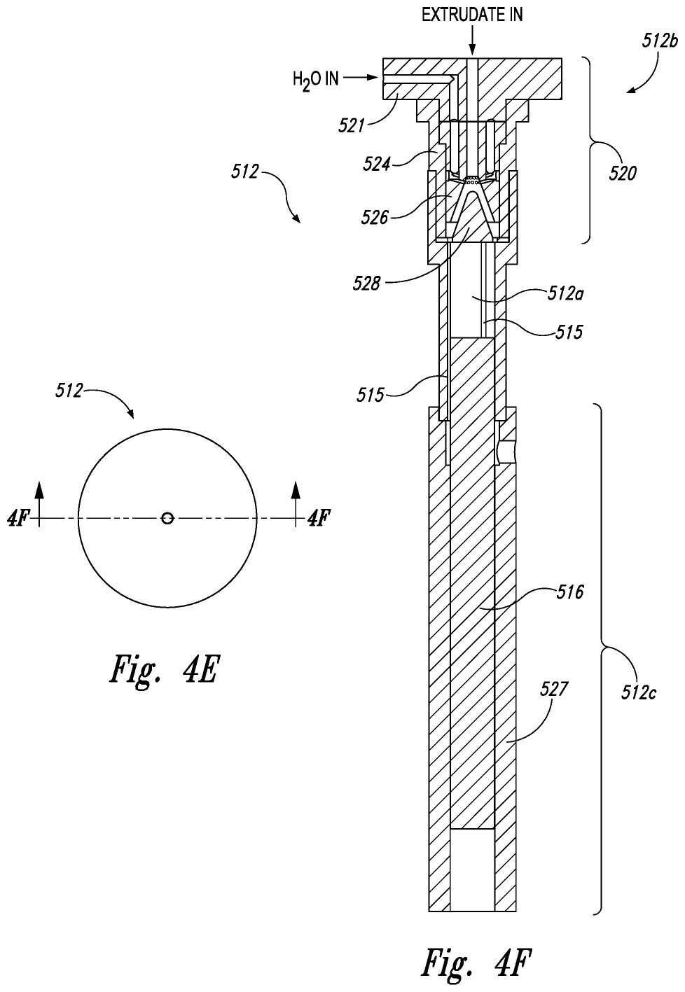

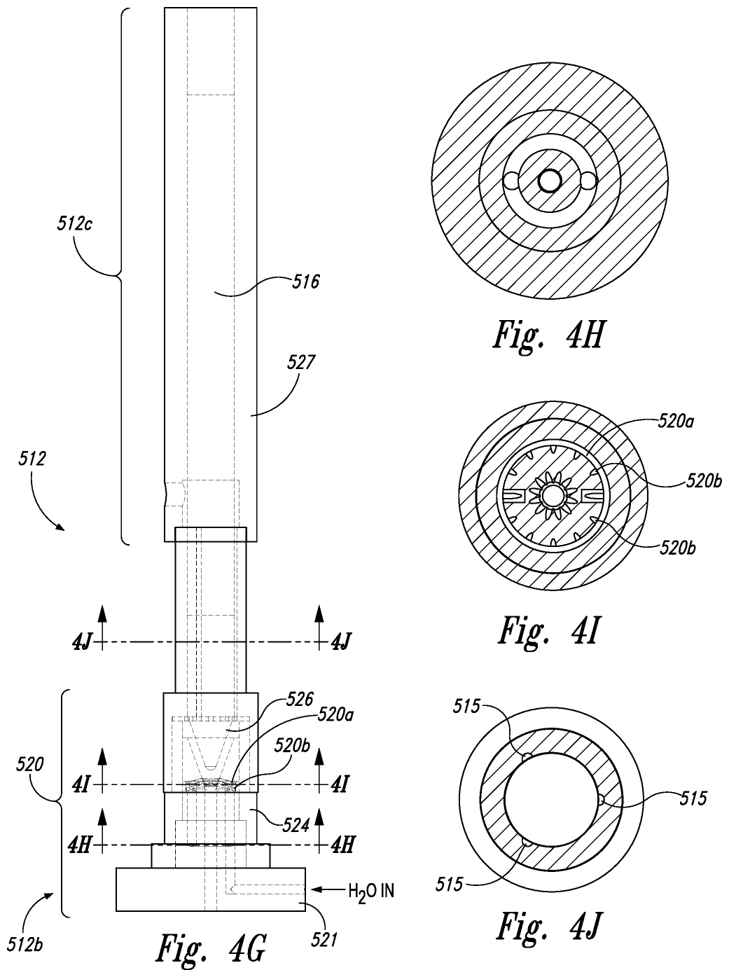

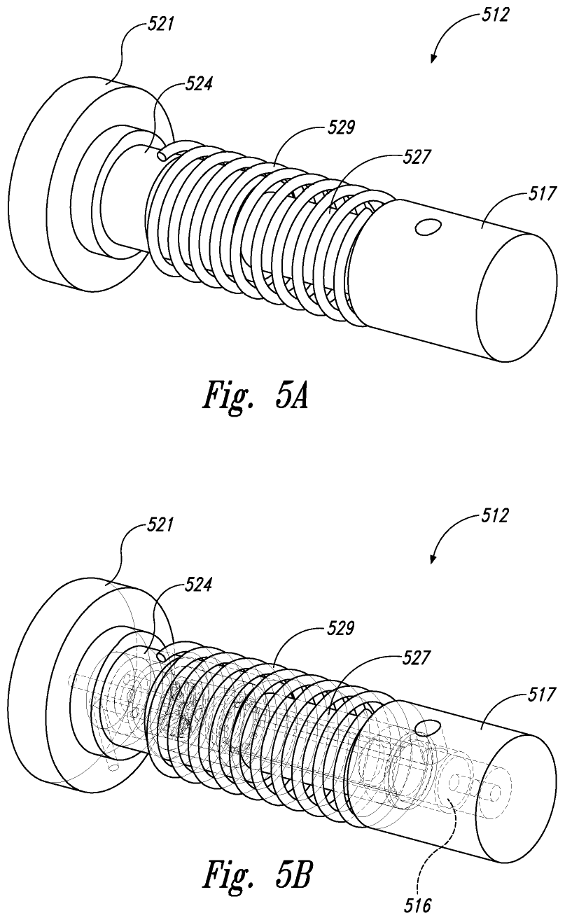

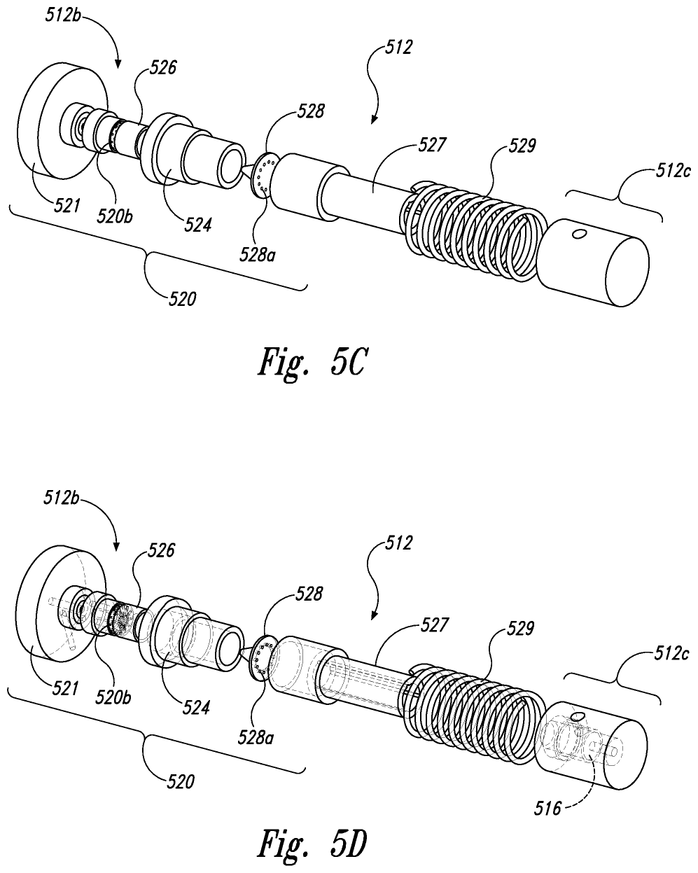

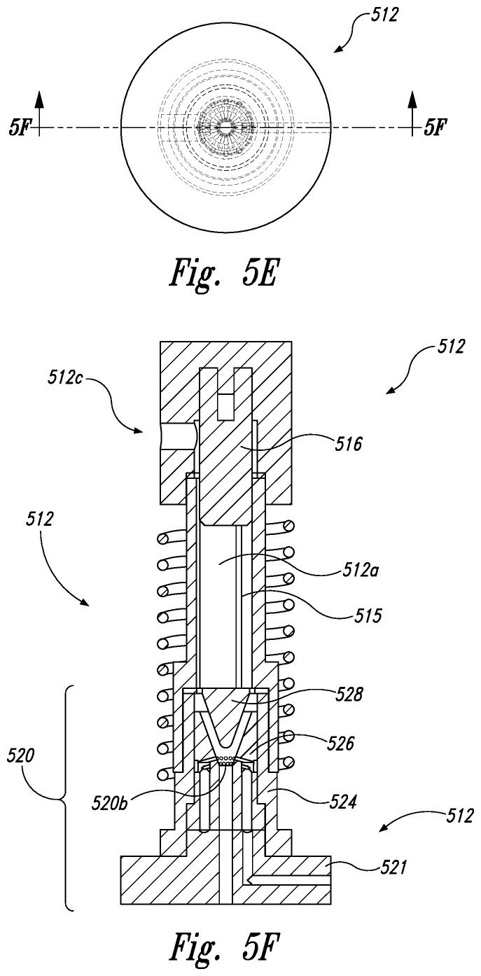

As still further depicted in the process flow diagram of FIG. 1 and in view of FIGS. 4A-J and FIGS. 5A-F (supercritical water reactor views), the central supercritical water reaction zone 300 (of the inventive system 10) comprises a tubular reactor 512 having (as best shown in FIG. 4F) an interior space 512a (plenum) that includes a plurality of reactor flow channels 515 fluidically connecting the inlet end 512b to the outlet end 512c (of the tubular reactor 512). The plurality of reactor flow channels 515 may, in some embodiments, be in the form of longitudinal grooves disposed along the inner wall of the central tubular reactor 512.

As shown, the tubular reactor 512 further comprises an inlet manifold 520 for evenly distributing the supercritical or high-energy water produced by the steam generator 216 about and into the molten extrudate (exiting the downstream outlet 114 of the extruder 110). As best shown in FIGS. 4G and 41, the inlet manifold 520 may form a ring 520a having a plurality of inwardly facing exit portals 520b (wherein the plurality of exit portals 520b is circumferentially positioned about the inner surface of the ring as shown). Thus, and in some embodiments, the inlet manifold 520 may comprise a manifold baseplate 521, a manifold housing 524, an inner manifold distributor 526, and a cone-shaped flow-through occlusion 528 (all of which components are nested together as shown to form the inlet manifold 520). The inlet manifold 520 is, in turn, connected to a tubular reactor shell component 527 of the tubular reactor 512.

As generally shown in the various views associated with FIGS. 4A-J, the inlet end 512b of the tubular reactor 512 is configured such that, under operating conditions, a flowing molten polymeric extrudate exiting the outlet 114 of the extruder 110 and entering into the interior space 512a of the tubular reactor 512 is radially impinged upon by the flowing supercritical or high-energy water that is simultaneously exiting out of the plurality of circumferentially positioned exit portals 520b. As depicted in FIG. 1, the inlet end 512b of the tubular reactor 512 is adjacent and fluidically connected to the outlet 114 of the extruder 110 (by means of an interposing metering valve 311). The novel and axially aligned cone-shaped flow-through occlusion 528 (having a plurality of reactant flow through-holes 528a positioned about the base plate of the cone portion) is centrally positioned near the tubular reactor's 512 inlet end 512b.

The cone-shaped flow-through occlusion 528 facilitates spreading and thinning of the centrally flowing molten extrudate (as the extrudate flows over the cone tip and then through the reactant flow through-holes 528a) during operation of the system 10. In other embodiments, the flow-through occlusion 528 takes the form of a hem i-spherical dome or even a flat plate having one or more holes or adjacent passageways. In this configuration, near-instantaneous liquefaction (and/or gasification) is achieved due to the regulated penetration and mixing of the molten target feedstock material with controlled or minimum amounts of supercritical water or high-energy water (to yield the plurality of hydrocarbon reaction products mixed with water).

As shown in the embodiments represented in FIGS. 5A-F, and in order to maintain set temperatures and steady-state operating conditions, a circumferentially positioned, high efficiency alternating current (AC) induction coil 529 (connected to and forming part of an induction heater—not shown) is positioned about the reactor shell component 527 of the tubular reactor 512 to supply additional heat energy (via computer control) when needed.

The novel tubular reactor 512, in some embodiments, further comprises a movable ram 516 centrally positioned within the tubular reactor 512. The ram 516 (which may be in the form of a piston or rod and is sometimes referred to as a “spear”) is movable back and forth (via a ram actuator—not shown) within and along the longitudinal axis of the tubular reactor 512 (to thereby increase or decrease the volume of the interior space 512a). In this way, the residence time of the supercritical water reaction occurring within the tubular reactor 512 (during operation of the system 10) may be selectively and dynamically controlled (with longer residence times corresponding to larger reactor volumes). Finally, an annular manifold reaction products outlet space 520 is positioned about the outlet end 512c of the tubular reactor 512. The reaction products outlet space 520 is fluidicly connected to the interior space 512a (plenum) (of the tubular reactor 512) by way of the plurality of reactor flow channels 515.

As still further depicted in FIG. 1, the downstream pressure let-down and reaction product separation zone 400 (of the inventive system 10) comprises another (a second) high pressure valve 410 (for controlling the flow rate of the plurality of hydrocarbon reaction products/water effluent exiting out of the tubular reactor 512) that, in turn, is fluidically connected to a downstream expansion (pressure let-down) chamber 412. The expansion chamber 412 expands and cools the compressed hydrocarbon reaction products/water mixture, thereby stopping further chemical reaction and allowing the hydrocarbon reaction products to coalesce (for example, to yield hydrocarbon oil droplets greater than 10 microns in diameter preferred in some embodiments). A third high pressure valve 414 (for controlling the flow rate of the plurality of hydrocarbon reaction products/water effluent exiting the expansion chamber 412) is positioned between, and fluidically connected to, both the expansion chamber 412 and a downstream static hydrocyclonic separator 416 (which component uses centrifugal force to remove the less dense hydrocarbon molecules from the water).

In still other embodiments and as depicted in FIG. 1, a heat exchanger 220 is preferably positioned before the expansion chamber 412 and is used to pre-heat the water feed into the steam generator 216 (thereby recovering heat energy and lowering the heat energy need to make supercritical water or near-supercritical water). In addition, second and third flow meters 413, 415 are preferably positioned inline before and after the downstream hydrocyclonic separator 416 (for monitoring and calculating the flow rates of the separated hydrocarbon and water flowstreams).

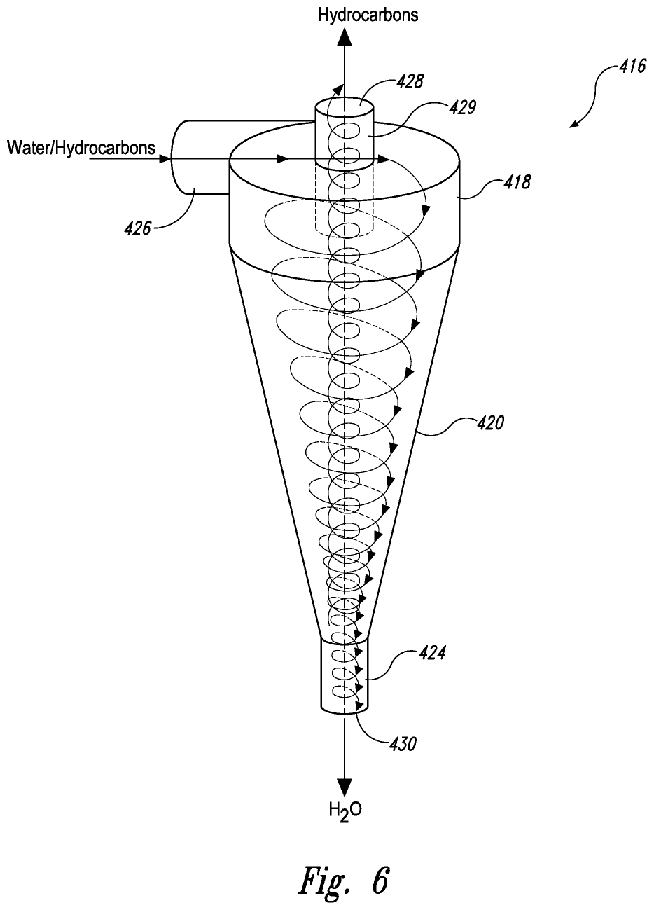

As best shown in FIG. 6, the hydrocyclonic separator 416 is configured to spin and substantially separate the plurality of hydrocarbon reactions products from the water and comprises, in fluidic series, (i) a cyclindrical swirl chamber section 418, (ii) a concentric tapered reducing section 420, and (iii) a cylindrical tail section 424. Under operating conditions, the plurality of hydrocarbon reaction products mixed with water enters into the cyclindrical swirl chamber section 418 through a tangential inlet 426 and creates a flowing vortex with a reverse-flowing central core. The lighter hydrocarbon reaction products exit the hydrocyclonic separator 416 through an axially aligned reaction products ejection port 428 connected at the end of a centrally positioned vortex finder 429 (which, in turn, is located (at least partially) within the cyclindrical swirl chamber section 418), whereas the water exits the hydrocyclonic separator 416 through an axially aligned tail section outlet 430 (and is preferably re-used again as feed water to the steam generator 216 as shown in FIG. 1).

During operations of the system 10, the combined hot flowing hydrocarbon products/water mixture effluent enters the cyclindrical swirl chamber section 418 through the tangential inlet 426 and swirls about the vortex finder 429, thereby creating a high-velocity vortex with a reverse-flowing central core. The hydrocarbon/water mixture accelerates as it flows through the concentric tapered reducing section 420, and continues at a near constant rate through the cyclindrical tail section 424. Centripetal forces cause the less dense hydrocarbon molecules to move toward the low-pressure central core, where axial reverse flow occurs.

In other embodiments, the supercritical hydrocyclotronic systems 10 of the present invention are sized and configured to fit, and be contained within, standard “intermodal” shipping or cargo containers (not shown) (and are thus readily transportable by way of ship, rail and/or truck to most locations throughout the world). Intermodal shipping containers are built to standardized dimensions, and can thus be loaded and unloaded, stacked, transported efficiently over long distances, and transferred from one mode of transport to another—container ships, rail and semi-trailer trucks—without being opened. An intermodal shipping container is generally defined as a standardized reusable steel box used for the safe, efficient and secure storage and movement of materials and products within a global containerized intermodal freight transport system. “Intermodal” indicates and means that the container can be moved from one mode of transport to another (from ship, to rail, to truck) without unloading and reloading the contents of the container. Lengths of containers, which each have a unique ISO 6346 intermodal reporting mark, vary from 8 feet (2.438 m) to 56 feet (17.07 m) and heights from 8 feet (2.438 m) to 9 feet 6 inches (2.9 m) and are all encompassed within the scope of the present invention.

While the present invention has been described in the context of the embodiments illustrated and described herein, the invention may be embodied in other specific ways or in other specific forms without departing from its full scope. Therefore, the described embodiments are to be considered in all respects as illustrative and not restrictive. The scope of the invention is, therefore, indicated by the appended claims rather than by the foregoing description, and all changes that come within the meaning and range of equivalency of the claims are to be embraced within their full scope.

1. A supercritical hydrocyclotron for transforming one or more selected organic materials into a plurality of reaction products via supercritical or near-supercritical water reaction, comprising:
a conveyor having an inlet and a downstream outlet;
a steam generator fluidically connected to a downstream inlet manifold, wherein the inlet manifold forms a ring having a plurality of inwardly facing exit portals, wherein the plurality of exit portals is circumferentially positioned about the inner surface of the ring;
a tubular reactor having an interior space fluidically connected to an inlet end and an outlet end, wherein the inlet end of the tubular reactor is adjacent and fluidically connected to both (i) the outlet of the conveyor, and (ii) the plurality of circumferentially positioned exit portals of the inlet manifold, and wherein the inlet end of the reactor also comprises an axially aligned occlusion having one or more through-holes, wherein the tubular reactor is configured such that, under operating conditions, a flowing polymeric extrudate exiting the outlet of the conveyor and entering into the interior space of the tubular reactor is spread by the occlusion and radially impinged upon by flowing hot compressed water and/or supercritical water that is exiting the plurality of circumferentially positioned exit portals to yield the plurality of reaction products mixed with water, and wherein the outlet end of the tubular reactor is fluidically connected to;
a hydrocyclonic separator, wherein the hydrocyclonic separator is configured to spin and substantially separate the plurality of reactions products from the water and comprises, in fluidic series, (i) a cyclindrical swirl chamber section, and (ii) a concentric tapered reducing section, and wherein, under operating conditions, the plurality of reaction products mixed with water exiting the outlet end of the tubular reactor enters into the cyclindrical swirl chamber section through a tangential inlet and creates a flowing vortex with a reverse-flowing central core within the hydrocyclonic separator, and wherein the plurality of reaction products exits the hydrocyclonic separator through an axially aligned reaction products ejection port located on the cyclindrical swirl chamber section, and wherein the water exits the hydrocyclonic separator through an axially aligned outlet.

2. The supercritical hydrocyclotron according to claim 1, further comprising an expansion chamber interposed between, and fluidicly connected to, the outlet end of the tubular reactor and the hydrocyclonic separator.

3. The supercritical hydrocyclotron according to claim 1, further comprising a cyclindrical vortex finder centrally positioned on and partially within the cylindrical swirl chamber, and wherein the axially aligned outlet is positioned on an outer end of the vortex finder.

4. The supercritical hydrocyclotron according to claim 1 wherein the conveyor is an extruder having an inlet and a downstream outlet, wherein the downstream outlet is coincident with the longitudinal axis of the extruder.

5. The supercritical hydrocyclotron according to claim 1 wherein the occlusion is generally cone-shaped.

6. The supercritical hydrocyclotron according to claim 5 wherein the inner surface of the ring of the inlet manifold is generally circular in shape, and wherein the cone shaped occlusion is concentrically positioned within the generally circle-shaped ring.

7. The supercritical hydrocyclotron according to claim 1, further comprising a ram centrally positioned within the tubular reactor, wherein the ram is movable back and forth within and along the longitudinal axis of the tubular reactor to thereby increase or decrease the volume of the interior space.

8. The supercritical hydrocyclotron according to claim 7, further comprising one or more flow channels fluidically connecting the inlet end of the tubular reactor to the outlet end of the tubular reactor, wherein the one or more flow channels form part of the interior space.

9. The supercritical hydrocyclotron according to claim 1, further comprising a heat exchanger configured to transfer heat from the plurality of reaction products mixed with water, under operating conditions, to an inlet water flowstream that feeds the steam generator.

10. A method for converting solid biomass and/or waste plastic materials into smaller hydrocarbon molecules, the method comprising the steps of:
conveying the solid biomass and/or waste plastic materials through a conveyor and into a downstream tubular reactor that comprises an axially aligned occlusion, wherein the occlusion is configured to spread the solid biomass and/or waste plastic materials and is located within a tubular reactor;
generating supercritical water or near-supercritical water substantially free of salts and minerals;
conveying the supercritical water or near-supercritical water into a downstream inlet manifold, wherein the inlet manifold forms a ring having a plurality of inwardly facing exit portals, wherein the plurality of exit portals is circumferentially positioned about the inner surface of the ring;
ejecting the supercritical water or near-supercritical water through the plurality of exit portals circumferentially positioned about the inner surface of the ring and into the tubular reactor and about the occlusion such that the supercritical water or near-supercritical water strikes and reacts with the solid biomass and/or waste plastic materials to yield the smaller hydrocarbon molecules mixed with water;
substantially separating the smaller hydrocarbon molecules from the water by creating a flowing vortex with a reverse-flowing central core within a hydrocyclonic separator and then removing the plurality of smaller hydrocarbon molecules from the hydrocyclonic separator through an axially aligned reaction products ejection while removing the water through an axially aligned tail section outlet.

11. The method according to claim 10, further comprising the step of cooling and coalescing the smaller hydrocarbon molecules mixed with water in an expansion chamber, wherein the expansion chamber is interposed between, and fluidicly connected to, an outlet end of the tubular reactor and a tangential inlet of the hydrocyclonic separator.
